(19) United States
(12) Patent Application Publication
(10) Pub. No.: US 2026/0058544 A1
(43) Pub. Date: Feb. 26, 2026

(54) Adaptive VTC for a Charge Pump

(71) Applicant: Micron Technology, Inc., Boise, ID (US)

(72) Inventors: Gopal Pulakala, Hyderabad (IN); Praveen Beniwal, Hyderabad (IN)

(21) Appl. No.: 19/222,714

(22) Filed: May 29, 2025

Related U.S. Application Data
(60) Provisional application No. 63/685,434, filed on Aug. 21, 2024.

(51) Int. Cl. H02M 1/32; H02M 3/07

(52) U.S. Cl. CPC H02M 1/327; H02M 3/07

(57) ABSTRACT

A memory device includes memory cells configured to store data and a charge pump. The charge pump includes a ring oscillator having an inverter and compensation circuitry configured to compensate for voltage and temperature changes for the charge pump. The compensation circuitry includes a first current source configured to selectively slow charging of a gate of the inverter during a charging phase and to selectively enhance discharging of the gate of the inverter during a discharging phase. The compensation circuitry also includes a second current source configured to selectively enhance charging of the gate of the inverter during the charging phase and to selectively slow discharging of the gate of the inverter during the discharging phase.

### CROSS-REFERENCE TO RELATED APPLICATION

This application claims priority to U.S. Provisional Application No. 63/685,434, filed Aug. 21, 2024, which is hereby incorporated by reference in its entirety.

### BACKGROUND

### Field of the Present Disclosure

Embodiments of the present disclosure relate generally to semiconductor devices (e.g., memory devices). More specifically, embodiments of the present disclosure relate to performing adaptive voltage and temperature compensation (VTC) for a charge pump.

### Description of Related Art

Generally, computing devices, such as memory devices, may use oscillators for charge pump-based level shifting. The charge pump-based level shifting performs voltage conversion using stored charge to shift from one voltage level to another. However, these pump oscillators may be very sensitive to process, voltage, or temperature (PVT) changes. In some embodiments, some pump oscillators may have process-dependent tuning to compensate for process changes that may mostly be time tuning, but some of these embodiments may not compensate for voltage or temperature changes that are dynamically changing parameters. Furthermore, most common resistor-capacitor (RC) ring oscillators may have a positive dependency of frequency on voltage that may cause drivability issues for low voltage or temperature conditions and poor power efficiency at high voltage or high temperature conditions.

Embodiments of the present disclosure may be directed to one or more of the problems set forth above.

### BRIEF DESCRIPTION OF THE DRAWINGS

FIG. 1 is a simplified block diagram illustrating certain features of a memory device having charge pump circuitry, according to an embodiment of the present disclosure;

FIG. 2 is a diagram of the charge pump circuitry of FIG. 1 with an RC ring oscillator, according to an embodiment of the present disclosure;

FIG. 3 is a graphical response of the pump oscillator of FIG. 2, according to an embodiment of the present disclosure;

FIG. 4 is a graphical response of the pump oscillator of FIG. 2 showing different use cases, according to an embodiment of the present disclosure;

FIG. 5 is a flow diagram of the pump oscillator of FIG. 2 with compensation, according to an embodiment of the present disclosure;

FIG. 6 is a graphical response of the pump oscillator of FIG. 5, according to an embodiment of the present disclosure; and

FIG. 7 is a detailed diagram of an embodiment of the pump oscillator of FIG. 5, according to an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As previously mentioned, pump oscillators of charge pumps may be susceptible to process, voltage, and temperature (PVT) changes. Accordingly, some pump oscillators may have process-dependent tuning, but such pump oscillators may still be susceptible to voltage and temperature changes. As discussed below, the pump oscillator may utilize an adaptive reverse supply voltage and adaptive inverse temperature-dependent frequency generator to improve both pump efficiency at high voltages and temperatures as well as driving ability at lower voltages and temperatures.

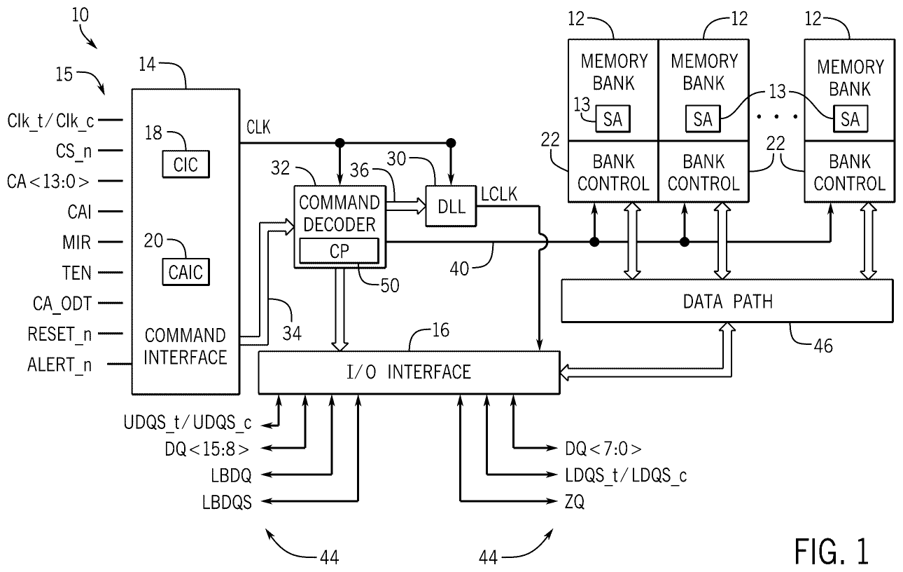

Turning now to the figures, FIG. 1 is a simplified block diagram illustrating certain features of a memory device 10. Specifically, the block diagram of FIG. 1 is a functional block diagram illustrating certain functionality of the memory device 10. In accordance with one embodiment, the memory device 10 may be a double data rate type five synchronous dynamic random-access memory (DDR5 SDRAM) device. Various features of DDR5 SDRAM allow for reduced power consumption, more bandwidth and more storage capacity compared to prior generations of DDR SDRAM. Furthermore, although the following discussion relates to DDR5 memory device, the testmode revision control scheme discussed herein may be likewise applied to any memory device of any suitable type that may have different testmodes between material revisions. Indeed, the testmode revision control scheme discussed herein may be applied to semiconductor devices beyond just memory devices for any semiconductor devices that may have different testmodes between material revisions.

The memory device 10 may include a number of memory banks 12. The memory banks 12 may be DDR5 SDRAM memory banks, for instance. The memory banks 12 may be provided on one or more chips (e.g., SDRAM chips) that are arranged on dual inline memory modules (DIMMS). Each DIMM may include a number of SDRAM memory chips (e.g., x8 or x16 memory chips), as will be appreciated. Each SDRAM memory chip may include one or more memory banks 12. The memory device 10 represents a portion of a single memory chip (e.g., SDRAM chip) having a number of memory banks 12. For DDR5, the memory banks 12 may be further arranged to form bank groups. For instance, for an 8 gigabyte (Gb) DDR5 SDRAM, the memory chip may include 16 memory banks 12, arranged into 8 bank groups, each bank group including 2 memory banks. For a 16 Gb DDR5 SDRAM, the memory chip may include 32 memory banks 12, arranged into 8 bank groups, each bank group including 4 memory banks, for instance. Various other configurations, organization and sizes of the memory banks 12 on the memory device 10 may be utilized depending on the application and design of the overall system.

The memory banks 12 and/or bank control blocks 22 include sense amplifiers 13. As previously noted, sense amplifiers 13 are used by the memory device 10 during read operations. Specifically, read circuitry of the memory device 10 utilizes the sense amplifiers 13 to receive low voltage (e.g., low differential) signals from the memory cells of the memory banks 12 and amplifies the small voltage differences to enable the memory device 10 to interpret the data properly.

The memory device 10 may include a command interface 14 and an input/output (I/O) interface 16. The command interface 14 is configured to provide a number of signals (e.g., signals 15) from an external (e.g., host) device (not shown), such as a processor or controller. The processor or controller may provide various signals 15 to the memory device 10 to facilitate the transmission and receipt of data to be written to or read from the memory device 10.

As will be appreciated, the command interface 14 may include a number of circuits, such as a clock input circuit 18 and a command address input circuit 20, for instance, to ensure proper handling of the signals 15. The command interface 14 may receive one or more clock signals from an external device. Generally, double data rate (DDR) memory utilizes a differential pair of system clock signals, the true clock signal Clk_t and the bar clock signal Clk_c. The positive clock edge for DDR refers to the point where the rising true clock signal Clk_t crosses the falling bar clock signal Clk_c, while the negative clock edge indicates that transition of the falling true clock signal Clk_t and the rising of the bar clock signal Clk_c. Commands (e.g., read command, write command, etc.) are typically entered on the positive edges of the clock signal and data is transmitted or received on both the positive and negative clock edges.

The clock input circuit 18 receives the true clock signal Clk_t and the bar clock signal Clk_c and generates an internal clock signal CLK. The internal clock signal CLK is supplied to an internal clock generator, such as a delay locked loop (DLL) circuit 30. The DLL circuit 30 generates a phase controlled internal clock signal LCLK based on the received internal clock signal CLK. The phase controlled internal clock signal LCLK is supplied to the I/O interface 16, for instance, and is used as a timing signal for determining an output timing of read data. In some embodiments, the clock input circuit 18 may include circuitry that splits the clock signal into multiple (e.g., 4) phases. The clock input circuit 18 may also include phase detection circuitry to detect which phase receives a first pulse when sets of pulses occur too frequently to enable the clock input circuit 18 to reset between sets of pulses.

The internal clock signal(s)/phases CLK may also be provided to various other components within the memory device 10 and may be used to generate various additional internal clock signals. For instance, the internal clock signal CLK may be provided to a command decoder 32. The command decoder 32 may receive command signals from the command bus 34 and may decode the command signals to provide various internal commands. For instance, the command decoder 32 may provide command signals to the DLL circuit 30 over the bus 36 to coordinate generation of the phase controlled internal clock signal LCLK. The phase controlled internal clock signal LCLK may be used to clock data through the IO interface 16, for instance.

Further, the command decoder 32 may decode commands, such as read commands, write commands, mode-register set commands, activate commands, etc., and provide access to a particular memory bank 12 corresponding to the command, via the bus path 40. As will be appreciated, the memory device 10 may include various other decoders (e.g., address decoders), such as row decoders and column decoders, to facilitate access to the memory banks 12. In one embodiment, each memory bank 12 includes the bank control block 22 which provides the necessary decoding (e.g., row decoder and column decoder), as well as other features, such as timing control and data control, to facilitate the execution of commands to and from the memory banks 12.

The memory device 10 executes operations, such as read commands and write commands, based on the command/address signals received from an external device, such as a processor. In one embodiment, the command/address bus may be a 14-bit bus to accommodate the command/address signals (CA<13:0>). The command/address signals are clocked to the command interface 14 using the clock signals (Clk_t and Clk_c). The command interface may include a command address input circuit 20, which is configured to receive and transmit the commands to provide access to the memory banks 12, through the command decoder 32, for instance. In addition, the command interface 14 may receive a chip select signal (CS_n). The CS_n signal enables the memory device 10 to process commands on the incoming CA<13:0> bus. Access to specific banks 12 within the memory device 10 is encoded on the CA<13:0> bus with the commands.

In addition, the command interface 14 may be configured to receive a number of other command signals. For instance, a command/address on die termination (CA_ODT) signal may be provided to facilitate proper impedance matching within the memory device 10. A reset command (RESET_n) may be used to reset the command interface 14, status registers, state machines and the like, during power-up for instance. The command interface 14 may also receive a command/address invert (CAI) signal which may be provided to invert the state of command/address signals CA<13:0> on the command/address bus, for instance, depending on the command/address routing for the particular memory device 10. A mirror (MIR) signal may also be provided to facilitate a mirror function. The MIR signal may be used to multiplex signals so that they can be swapped for enabling certain routing of signals to the memory device 10, based on the configuration of multiple memory devices in a particular application. Various signals to facilitate testing of the memory device 10, such as the test enable (TEN) signal, may be provided, as well. For instance, the TEN signal may be used to place the memory device 10 into a testmode for connectivity testing.

The command interface 14 may also be used to provide an alert signal (ALERT_n) to the system processor or controller for certain errors that may be detected. For instance, an alert signal (ALERT_n) may be transmitted from the memory device 10 if a cyclic redundancy check (CRC) error is detected. Other alert signals may also be generated. Further, the bus and pin for transmitting the alert signal (ALERT_n) from the memory device 10 may be used as an input pin during certain operations, such as the connectivity testmode executed using the TEN signal, as described above.

Data may be sent to and from the memory device 10, utilizing the command and clocking signals discussed above, by transmitting and receiving data signals 44 through the IO interface 16. More specifically, the data may be sent to or retrieved from the memory banks 12 over the data path 46, which includes a plurality of bi-directional data buses. Data IO signals, generally referred to as DQ signals, are generally transmitted and received in one or more bi-directional data busses. For certain memory devices, such as a DDR5 SDRAM memory device, the IO signals may be divided into upper and lower bytes. For instance, for a x16 memory device, the IO signals may be divided into upper and lower IO signals (e.g., DQ<15:8> and DQ<7:0>) corresponding to upper and lower bytes of the data signals, for instance.

To allow for higher data rates within the memory device 10, certain memory devices, such as DDR memory devices may utilize data strobe signals, generally referred to as DQS signals. The DQS signals are driven by the external processor or controller sending the data (e.g., for a write command) or by the memory device 10 (e.g., for a read command). For read commands, the DQS signals are effectively additional data output (DQ) signals with a predetermined pattern. For write commands, the DQS signals are used as clock signals to capture the corresponding input data. As with the clock signals (Clk_t and Clk_c), the DQS signals may be provided as a differential pair of data strobe signals (DQS_t and DQS_c) to provide differential pair signaling during reads and writes. For certain memory devices, such as a DDR5 SDRAM memory device, the differential pairs of DQS signals may be divided into upper and lower data strobe signals (e.g., UDQS_t and UDQS_c; LDQS_t and LDQS_c) corresponding to upper and lower bytes of data sent to and from the memory device 10, for instance.

An impedance (ZQ) calibration signal may also be provided to the memory device 10 through the IO interface 16. The ZQ calibration signal may be provided to a reference pin and used to tune output drivers and ODT values by adjusting pull-up and pull-down resistors of the memory device 10 across changes in process, voltage and temperature (PVT) values. Because PVT characteristics may impact the ZQ resistor values, the ZQ calibration signal may be provided to the ZQ reference pin to be used to adjust the resistance to calibrate the input impedance to known values. As will be appreciated, a precision resistor is generally coupled between the ZQ pin on the memory device 10 and GND/VSS external to the memory device 10. This resistor acts as a reference for adjusting internal ODT and drive strength of the IO pins.

In addition, a loopback data signal (LBDQ) and loopback strobe signal (LBDQS) may be provided to the memory device 10 through the IO interface 16. The loopback data signal and the loopback strobe signal may be used during a test or debugging phase to set the memory device 10 into a mode wherein signals are looped back through the memory device 10 through the same pin. For instance, the loopback signal may be used to set the memory device 10 to test the data output (DQ) of the memory device 10. Loopback may include both LBDQ and LBDQS or possibly just a loopback data pin. This is generally intended to be used to monitor the data captured by the memory device 10 at the IO interface 16. LBDQ may be indicative of a target memory device, such as memory device 10, data operation and, thus, may be analyzed to monitor (e.g., debug and/or perform diagnostics on) data operation of the target memory device. Additionally, LBDQS may be indicative of a target memory device, such as memory device 10, strobe operation (e.g., clocking of data operation) and, thus, may be analyzed to monitor (e.g., debug and/or perform diagnostics on) strobe operation of the target memory device.

As will be appreciated, various other components such as power supply circuits (for receiving external VDD and VSS signals), mode registers (to define various modes of programmable operations and configurations), read/write amplifiers (to amplify signals during read/write operations), temperature sensors (for sensing temperatures of the memory device 10), etc., may also be incorporated into the memory device 10. Accordingly, it should be understood that the block diagram of FIG. 1 is only provided to highlight certain functional features of the memory device 10 to aid in the subsequent detailed description. Furthermore, although the foregoing discusses the memory device 10 as being a DDR5 device, the memory device 10 may be any suitable device (e.g., a double data rate type 4 DRAM (DDR4), a ferroelectric RAM device, or a combination of different types of memory devices).

As previously noted, the memory device 10 or any other electronic devices that may use one or more charge pumps 50 to perform level shifting between different voltage levels in the memory device 10. A charge pump 50 is a type of DC-to-DC converter that uses capacitors and a switch network controlled by clock phases. An output voltage, the pumping voltage, resulting from the charge pump may be used to provide an output voltage that may be used as part of a memory operation. For example, the output of the charge pump 50 may be an output voltage used as a word line activation voltage. Furthermore, the location of the charge pumps 50 may be shown in the command decoder 32 in the illustrated embodiment of the memory device 10. However, one or more charge pumps 50 may be located in place of or in addition to the one or more charge pumps 50 in the command decoder 32.

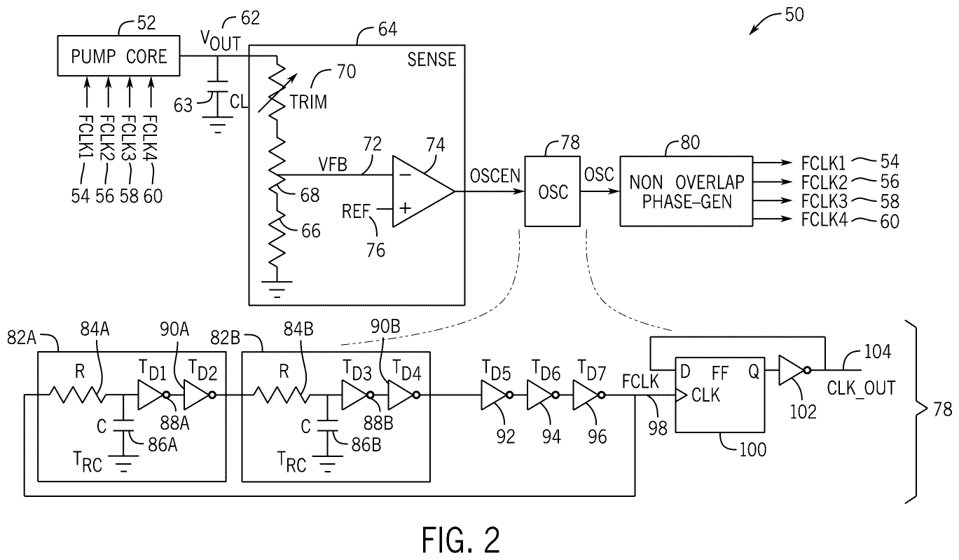

FIG. 2 is a diagram of an embodiment of the charge pump 50 of FIG. 1. As illustrated, the charge pump 50 includes a pump core 52 that performs charge storing and transferring of charge using non-overlapping clocks: Fclk1 54, Fclk2 56, Fclk3 58, and Fclk4 60. These clocks are used to control switching in the pump core 52 to control charging and discharging of charge in capacitors of the pump core 52 based on the clocks. An output voltage (VOUT) 62 from the pump core may be coupled to a capacitor CL 63 that is also coupled to ground. The capacitor CL 63 is referred to as the output capacitor as VOUT 62 is the output voltage. The amplitude of VOUT 62 is proportional to a supply voltage using a conversion ratio that is a ratio of the output voltage to the supply voltage. The conversion ratio depends on the switch network configuration of the pump core 52. To increase the conversion ratio more unit stages may be used in a same but repeated configuration. The charge pump 50 may control its own frequency using sense circuitry 64 used to control whether oscillation is enabled or disabled. The sense circuitry 64 includes resistors 66, 68, and 70 coupled in series between VOUT 62 and the ground. The resistor 70 may be a variable/trimmable resistor to compensate for process variations in the charge pump 50 output voltage level to trim process and design offsets between different reproductions of the charge pump 50. The resistor 68 is also coupled to output feedback voltage (vfb) 72 that is input to a comparator 74 along with a reference voltage 76. The output of the comparator 74 is used to disable or enable a pump oscillator 78 when vfb 72 crosses a threshold voltage. The pump oscillator 78, when enabled, outputs an oscillation clock (osc) to non-overlap phase generation circuitry 80 that is used to generate the clocks Fclk1 54, Fclk2 56, Fclk3 58, and Fclk4 60 as different phases of the oscillation clock to be fed into the pump core 52.

FIG. 2 also shows a more detailed view of an embodiment of the pump oscillator 78 that is a RC-based ring oscillator implementation. Ring oscillators are oscillators that use an odd number of inverters in series that feeds back the output of a last inverter as an input back to a first inverter to form a ring. The odd number of inverters causes logical instability where the voltages continually oscillate at a rate that is controlled by the delay through the portions of oscillator 78, such as the inverters, resistors, and capacitors. For instance, the delay through each inverter is shown with a respective gate delay (T_{D}). As illustrated, the RC-based ring oscillator implementation of the pump oscillator 78 includes a first stage 82A made up of an RC network including a resistor (R) 84A and a capacitor (C) 86A and inverters 88A and 90A. The illustrated pump oscillator 78 is a two-stage oscillator having the first stage 82A and a second stage 82B. Like the first stage 82A, the second stage 82B is made up of an RC network including a resistor (R) 84B and a capacitor (C) 86B and inverters 88B and 90B. In some embodiments, the number of stages may be different than two, such as 1, 3, 4, or more stages.

The output from the stages 82 is fed into one or more inverters 92, 94, and 96. As illustrated, the pump oscillator 78 includes three inverters after the stages, but may include any suitable number of inverters, such as 1, 2, 3, 4, 5, or more after the stages (depending on the number of inverters in the stages). The ring of the pump oscillator 78 outputs a clock Fclk 98 that is transmitted to a clock input of a flip flop 100. The flip flop 100 has its output coupled to an inverter 102 that outputs an output clock (clk_out or oscillated clock) 104 that is fed back to a data input of the flip flop 100. This usage of the flip flop 100 corrects any duty cycle error and divides the frequency by two.

However, as previously noted, the pump oscillator 78 may be subject to PVT changes. Trim settings may compensate for some of the process dependency but may provide no compensation for temperature and/or voltage settings that are primarily dynamically changing parameters that cannot be addressed using static trimming like process errors may be corrected. Furthermore, the frequency of the supply has a positive correlation with the supply of the pump oscillator 78 that can lead to reduced drivability at low voltages and/or temperatures and lead to reduced efficiency at high voltages and/or temperatures. To meet capacity numbers for worst case scenarios, higher power supplies may be used thereby causing the pump core 52 to consume more area for larger components (e.g., larger drivers, capacitors, etc.) or suffer power loss. Hence, at higher supply and temperature levels, the efficiency will be even more poor.

Since the frequency of the clk_out 104 depends on propagation through the oscillator 78 of an on pulse through both stages 82 and an off pulse through both stages 82 of the oscillator 78, the time period (T_{CLK}) of the clk_out 104 may be represented by the following equation when the gate delay (T_{D}) through each of the seven inverters is relatively smaller than the RC delay (T_{RC}):

$${T}_{CLK} = 4 {T}_{RC} + 20 {T}_{D} = α4 RC + 20 {T}_{D} . \qquad ( Equation 1 )$$

Equation 1 implies that the frequency of the clk_out 104 does not vary with supply for the ring oscillator, but frequency may have a strong frequency in reality. For instance, Equation 2 may show the RC delay of the first stage 82A and/or the second stage 82B:

$${T}_{RC} = - τ ln ( 1 - ( \frac{K ( {V}_{in} ) + \frac{{V}_{in}}{RC} * tdn}{{V}_{in}} ) ) , \qquad ( Equation 2 )$$

where τ=RC of 84A and 86A and/or 84B and 86B, Vᵢₙ is the supply voltage, K is the percentage of the trip point of the inverter 88A and/or 88B, and tdn is the gate delay of the nth inverter. Equation 2 may be manipulated into Equation 3 using

$${k}_{eff} = {μ}_{n} {C}_{ox} \frac{W}{L}$$

and C_{gate} is the total gate capacitance at inverter 88A and/or 88B:

$${T}_{RC} = - τ ln ( 1 - ( K + \frac{1}{RC} * \frac{{c}_{gate}}{{k}_{eff} ( {V}_{in} - {V}_{th} )} ) ) . \qquad ( Equation 3 )$$

Using Equation 3 (or an approximation thereof), it becomes clear that the time period of the clk_out 104 is inversely proportional to the voltage, and thus, the frequency is directly proportional to the supply voltage. Therefore, as the supply voltage increases, the frequency increases, and when the supply voltage decreases the frequency decreases. However, this relationship is opposite of desirable as the frequency should be inversely correlated to the supply voltage to improve pump efficiency at high voltage and/or temperature and to improve drivability at low voltage and/or temperature.

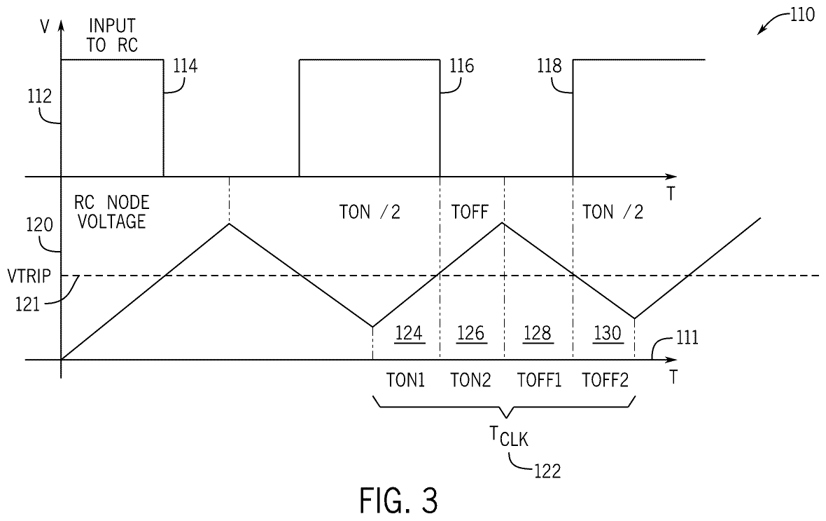

FIG. 3 is a graph 110 of a response over time 111 of the supply voltage 112 with pulses 114, 116, and 118. The graph 110 also shows the response output 120 along with a trip voltage 121 of the oscillator 78. As shown, the time period (T_{CLK}) 122 may be divided into Ton1 124, Ton2 126, Toff1 128, and Toff2 130, where Ton1 124 corresponds to the duration for the output 120 to increase from a low trough to the trip voltage 121, Ton2 126 corresponds to the duration for the output 120 to increase from the trip voltage 121 to the peak, Toff1 128 corresponds to the duration for the output 120 to decrease from the peak to the trip voltage 121, and Toff2 130 corresponds to the duration for the output 120 to decrease from the trip voltage 121 to the low trough.

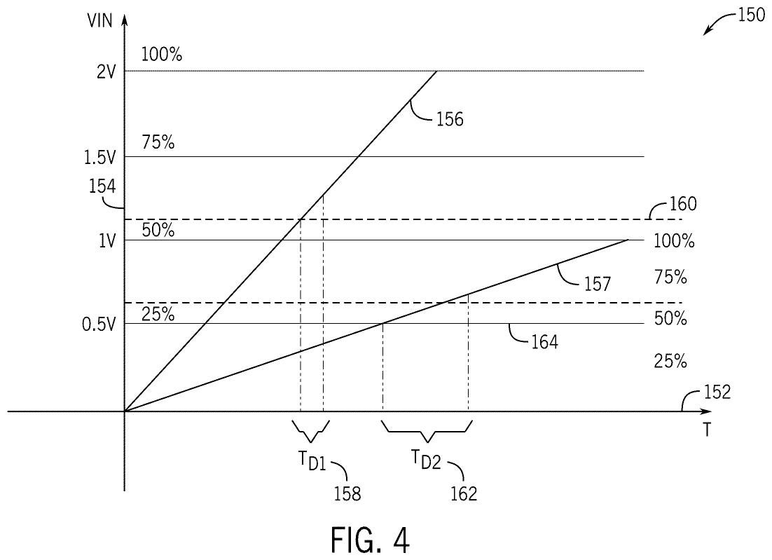

FIG. 4 is a graph 150 showing the response of the oscillator 78 to different use cases over time 152 for different input voltages 154. The graph 150 includes a line 156 that corresponds to a high input voltage case (e.g., 100%=2V) and a line 157 that corresponds to a low input voltage case (e.g., 100%=1V). The line 156 has a corresponding delay (td1) 158 that occurs after switching at trip voltage 160. The line 157 has a corresponding delay (td2) 162 that occurs after switching at trip voltage 164. As illustrated, the switching for the high input voltage case occurs where the gate of the respective inverter is charging until 50% of the maximum of the input voltage 154 while the switching for the low input voltage case occurs where the gate of the respective inverter is charging until almost 75% of the maximum of the input voltage 154. In other words, the low input voltage case results in a higher charging and discharging duration leading to a higher time period. This issue of variable frequency may be at least partially addressed by causing the charging points for both cases to be the same or at least closer together.

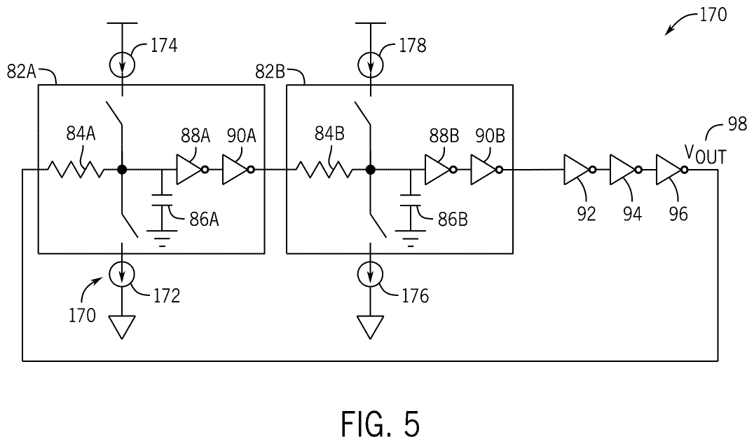

One mechanism to make performance more consistent between different temperature and voltages may include magnitude and slope compensation to slow at least part of the charging and/or discharging phases (e.g., Ton1 124, Ton2 126, Toff1 128, or Toff2 130) to use more (e.g., 100%) of the time period for charging and discharging. This greater utilization may use less current to get a relatively high slope when compared to the lower utilization. One mechanism to perform such compensation may need different charging and discharging elements. Such as complementary current sources that slow charging and/or discharging in the oscillator 78. For instance, FIG. 5 is a circuit diagram of the oscillator 78 with compensation circuitry 170 that performs such compensation. For instance, the compensation circuitry 170 may include a current source 172 to slow charging at the gate of the inverter 88A during a first charging phase (e.g., Ton1 124) by drawing current from the input voltage of the inverter 88A, also known as slope trimming. During a second charging phase (e.g., Ton2 126) after the input voltage has crossed the trip voltage, a switch turns off the current source 172 when a complementary switch turns on a current source 174 that pumps more current into the gate of the inverter 88A. By dumping more charge into the gate of the inverter 88A, the compensation circuitry 170 slows discharge of the charge of the gate of the inverter in later discharge phases, which leads the magnitude to shift up causing the discharging from that peak to take more time. This magnitude boosting may also be referred to as magnitude trimming.

As noted above, at the beginning of a first discharge phase (e.g., Toff1 124), the voltage at the gate of the inverter 88A has a higher voltage due to the charging from the current source 174. This extra charge slows the total discharge. Additionally, the current source 174 continues to pump charge into the input voltage further slowing discharge of the input voltage during the first discharge phase. After the input voltage drops below the trip voltage, a second discharge phase (e.g., Toff2 126) begins. During the second discharge phase, a switch disconnects the current source 174 from the input voltage, and another switch reconnects the current source 172 to the input voltage. During this second discharge phase, the current source 172 increases the magnitude of the downward swing to a negative trough for the input voltage. By lowering the negative trough, the next charging phases (e.g., Ton1 124 and/or Ton2 126) after the second discharge phase are slowed. During the first of these charging phases (e.g., Ton1 124), the current source 172 remains active to slow charging. This cycle of slowed first charging phase (e.g., Ton1 124) followed by a magnitude-increased second charging phase (e.g., Ton2 126) followed by a slowed first discharging phase (e.g., Toff1 128) followed by a magnitude-decreased second discharging phase (e.g., Toff2 130) repeats.

The compensation circuitry 170 also includes current sources 176 and 178 that function to control charging and discharging to the inverter 88B in the stage 82B similarly to how the current sources 172 and 174 are used to control charging and discharging to the inverter 88A in the stage 82A discussed previously.

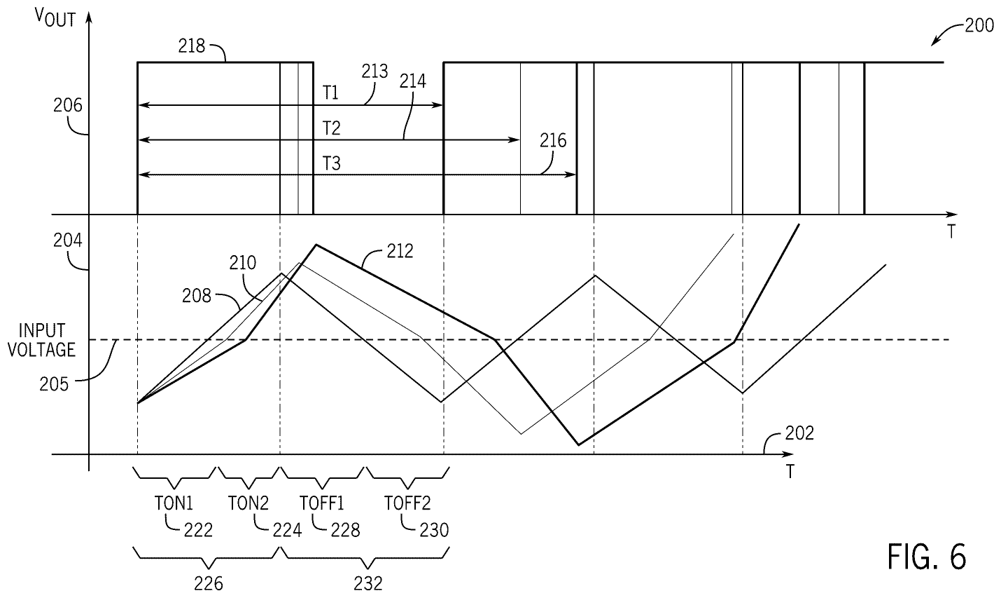

FIG. 6 is a graph 200 over time 202 of an input voltage 204 of the inverter 88A and/or the inverter 88B. The graph 200 also includes an output voltage 204 of the oscillator 78 along with its corresponding trip voltage 205. The graph 200 also shows a line 208. The line 208 may correspond to a non-compensated input voltage 204, such as using the oscillator 78 of FIG. 2 without the compensation circuitry 170 of FIG. 5 and/or using the compensation circuitry 170 with a relatively low input voltage to the oscillator 78. The graph 200 also shows a line 210 using the compensation circuitry 170 with a first input voltage to the oscillator 78 and a line 212 using the compensation circuitry 170 with a second input voltage to the oscillator 78. As illustrated, the output voltage of the oscillator 78 may have a time period 213 for the line 208, a time period 214 for the line 210, and a time period for the line 212 between respective pulses 218.

The illustrated lines 208, 210, and 212 are divided into a first charging phase (Ton1) 222 with slow charging and a second charging phase (Ton2) 224 with magnitude boosting of a charging portion 226. The first charging phase (Ton1) 222 and the second charging phase (Ton2) 224 are separated by the crossing of the respective line over the trip voltage 205 that causes an inversion and respective switches to change. The illustrated lines 208, 210, and 212 are also divided into a first discharging phase (Toff1) 228 with slow discharging and a second discharging phase (Toff2) 230 with a faster discharge to lower the charge of a discharging portion 232. The first discharging phase (Toff1) 228 and the second discharging phase (Toff2) 230 are separated by the crossing of the respective line over the trip voltage 205 that causes an inversion and respective switches to change. Due to the connection of the current sources 172, 174, 176, and 178, their respective switches cause changes/deflections in the slope and magnitude between the Ton1 222 and the Ton2 224 and changes/deflections in the slope and magnitude between the Toff1 228 and the Toff2 230. Specifically, the current sources 172 and 176 decrease the slope in the Ton1 222 and the Toff1 228, and the current sources 174 and 178 increases the magnitude of the slope in the Ton2 224 and the slope in the Toff2 230 to increase magnitude of peaks and troughs to decrease the charging/discharging in the next Ton1 222 and Toff1 228. As previously noted, these compensation techniques may at least partially compensate for the voltage and temperature issues previously discussed. In some embodiments, the compensation may more than compensate by inverting the relationship between the frequency of the output voltage 206 to be inversely correlated to the input voltage to the oscillator 78.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims. Furthermore, the compensation circuitry 170 may provide a fast response that increase pump efficiency at high voltages and/or temperatures and provides a large driving ability at lower voltages and/or temperatures without requiring a constant/static current (e.g., DC current) from the supply to ground since such compensation is performed using switches to use only a switched current when the sources are coupled to the gate of the inverter 88A or 88B. Furthermore, the current sources may provide non-linear current with regard to the input voltage for linear increments of frequency. In addition to the supply and temperature compensation, the compensation circuitry 170 establishes process feedback. The current sources also may have relatively low area blast and minor deflection from the implementation in FIG. 2 making the compensation circuitry 170 easily applicable to any RC-based ring oscillator.

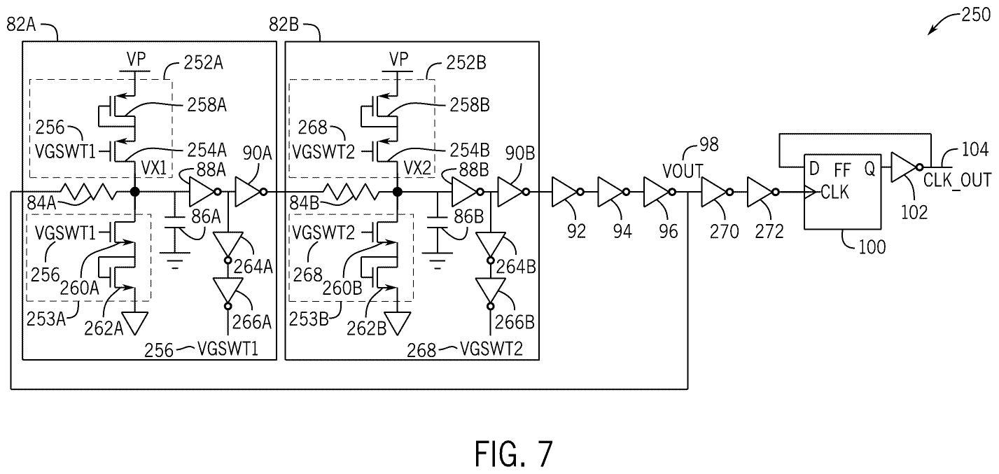

FIG. 7 is a circuit diagram of an embodiment 250 of the oscillator 78 using compensation circuitries 252 (including 252A and 252B) and 253 (including 253A and 253B) as embodiments of the compensation circuitry 170. As illustrated, the compensation circuitry 252A includes a transistor 258A that acts as a current source that is selectively connected to the inverter 88A using transistor 254A that selectively connects the transistor 258A to the inverter 88A based on Vgswt1 256. The compensation circuitry 253A includes a transistor 262A that acts as a current source that is selectively connected to the inverter 88A using transistor 260A that selectively connects the transistor 262A to the inverter 88A based on the Vgswt1 256. Vgswt1 256 is derived from an output of the inverter 88A through inverters 264A and 266A. Since Vgswt1 256 is tied to the output of the inverter 88A with delays through inverters 264A and 264B, the Vgswt1 256 tracks when the voltage crosses a trip voltage or threshold voltage for the transistors 254A and 260A. Furthermore, the transistors 258A and 254A may be complementary in nature with the transistors 262A and 260A. For instance, as illustrated, the transistors 254A and 258A are NMOS transistors while the transistors 262A and 260A are PMOS transistors. This causes only one of the transistors 254A or 260A to be active at one time.

As illustrated, the compensation circuitry 252B includes a transistor 258B that acts as a current source that is selectively connected to the inverter 88B using transistor 254B that selectively connects the transistor 258B to the inverter 88B based on Vgswt2 268. The compensation circuitry 253B includes a transistor 262B that acts as a current source that is selectively connected to the inverter 88B using transistor 260B that selectively connects the transistor 262B to the inverter 88B based on the Vgswt2 268. Vgswt2 268 is derived from an output of the inverter 88B through inverters 264B and 266B. Since Vgswt2 268 is tied to the output of the inverter 88B with delays through inverters 264B and 264B, the Vgswt2 268 tracks when the voltage crosses a trip voltage or threshold voltage for the transistors 254B and 260B. Furthermore, the transistors 258B and 254B may be complementary in nature with the transistors 262B and 260B. For instance, as illustrated, the transistors 254B and 258B are NMOS transistors while the transistors 262B and 260B are PMOS transistors. This causes only one of the transistors 254B or 260B to be active at one time. In the illustrated embodiment, the compensation circuitry 170 in compensation circuitries 252 and 253 along with the flip flop 100 and the inverters 270, 272, and 102 may be driven using a first voltage (Vp) as their supply voltage while the remaining portions use a different voltage for their supplies, which is somewhat constant across supply and temperature levels.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A device, comprising:
a charge pump to provide a pumping voltage that enables level shifting to convert an input voltage to an output voltage with the output voltage having a different voltage level than the input voltage, wherein the charge pump comprises an oscillator comprising:
a ring oscillator having an inverter; and
compensation circuitry configured to compensate for voltage and temperature changes for the charge pump, wherein the compensation circuitry comprises:
a first current source configured to selectively slow charging of a gate of the inverter during a charging phase and to selectively enhance discharging of the gate of the inverter during a discharging phase; and
a second current source configured to selectively enhance charging of the gate of the inverter during the charging phase and to selectively slow discharging of the gate of the inverter during the discharging phase.

2. The device of claim 1, wherein the first current source is configured to slow charging of the gate of the inverter and the second current source is configured to enhance charging of the gate of the inverter during different portions of the charging phase.

3. The device of claim 2, wherein the first current source is configured to slow charging of the gate of the inverter during the charging phase before the second current source enhances charging of the gate of the inverter during the charging phase.

4. The device of claim 3, wherein the second current source is configured to slow discharging of the gate of the inverter and the first current source is configured to enhance discharging of the gate of the inverter during different portions of the discharging phase.

5. The device of claim 4, wherein the second current source is configured to slow discharging of the gate of the inverter before the first current source enhances discharging of the gate of the inverter during the discharging phase.

6. The device of claim 1, wherein the compensation circuitry comprises:
a first switch configured to selectively couple the first current source to the gate of the inverter; and
a second switch configured to selectively couple the second current source to the gate of the inverter.

7. The device of claim 6, wherein the first switch and the second switch are complementary so that only one of the first or second switch is active at a time.

8. The device of claim 6, wherein the first switch and the second switch are driven using a single control signal.

9. The device of claim 8, wherein the first switch comprises a p-type transistor and the second switch comprises an n-type transistor.

10. The device of claim 8, wherein the single control signal is based at least in part on an output of the inverter.

11. The device of claim 1, wherein the ring oscillator comprises an additional inverter, and the compensation circuitry comprises a third current source and a fourth current source.

12. The device of claim 11, wherein the compensation circuitry comprises:
a first switch configured to selectively couple the first current source to the gate of the inverter;
a second switch configured to selectively couple the second current source to the gate of the inverter;
a third switch configured to selectively couple the third current source to a gate of the additional inverter; and
a fourth switch configured to selectively couple the fourth current source to the gate of the additional inverter.

13. The device of claim 12, wherein the first switch and the second switch are configured to use a first control signal to control when to toggle, and the third switch and the fourth switch are configured to use a second control signal to control when to toggle.

14. The device of claim 13, wherein the first control signal is based at least in part on an output of the inverter, and the second control signal is based at least in part on an output of the additional inverter.

15. A method for operating a memory device having a charge pump, comprising:
using a first current source to slow charging of a gate of an inverter of the charge pump during a first portion of a charging phase;
using a second current source to enhance charging of the gate of the inverter of the charge pump during a second portion of the charging phase;
using the second current source to slow discharging of the gate of the inverter of the charge pump during a first portion of a discharging phase; and
using the first current source to enhance discharging of the gate of the inverter of the charge pump during a second portion of the discharging phase.

16. The method of claim 15, wherein:
using the first current source to slow charging and to enhance discharging each comprises coupling the first current source to the gate using a first switch and disconnecting the second current source from the gate using a second switch; and
using the second current source to enhance charging and to slow discharging of the gate comprises coupling the second current source to the gate using the second switch and disconnecting the first current source from the gate using the first switch.

17. The method of claim 15, wherein the first portion of the charging phase precedes the second portion of the charging phase that precedes the first portion of the discharging phase that precedes the second portion of the discharging phase.

18. The method of claim 15, wherein the charging phase precedes the discharging phase.

19. The method of claim 18, wherein the charging phase and the discharging phase together form a time period of a single wave of an oscillator of the charge pump.

20. Charge pump circuitry comprising:
a pump core that utilizes one or more frequencies;
a ring oscillator comprising:
an inverter comprising a gate configured to receive an input voltage and to transmit an output based on the input voltage;
a first current source configured to siphon current from the gate of the inverter;
a first switch configured toggle a first connection between the first current source and the gate based on a control signal;
a second current source configured to transmit current to the gate of the inverter;
a second switch configured toggle a second connection between the second current source and the gate based on the control signal; and
a string of inverters coupled to the output of the inverter and configured to output the control signal.
